(19) United States
(12) Patent Application Publication
(10) Pub. No.: US 2008/0219687 A1
(43) Pub. Date: Sep. 11, 2008

(54) IMAGE FORMING APPARATUS AND CONTROL METHOD THEREOF

(75) Inventor: Hisatomi Shinichi, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/042,580

(22) Filed: Mar. 5, 2008

(30) Foreign Application Priority Data
Mar. 9, 2007 (KR) 2007-23523

(51) Int. Cl. G03G 15/10

(52) U.S. Cl. 399/60

(57) ABSTRACT

An image forming apparatus and a control method thereof. The image forming apparatus includes an image input part, a development unit which is supplied with a toner and forms a developer to develop an input image inputted from the image input part, a transfer member to form a patch image, a density sensor which detects density of the patch image, and a toner supply amount control unit which sets a toner supply amount of the development unit according to changed density of the patch image which is detected by the density sensor with a predetermined detecting cycle and applies the set toner supply amount to operation of printing the input image. Accordingly, a cycle of test printing the patch image can be extended to a longer period, unnecessary consumption of the toner is prevented, and the density of the printed image can be maintained stably.

### CROSS-REFERENCE TO RELATED APPLICATIONS

This application claims the benefit of Korean Patent Application No. 2007-0023523, filed on Mar. 9, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus, and more particularly, to an image forming apparatus and a control method thereof that adjusts a toner supply amount according to change in density of image quality of a patch image.

2. Description of the Related Art

An image forming apparatus includes a toner density sensor to control image density to apply a two-component developer. Examples of the image forming apparatus are disclosed in Japanese Patent Laid-Open Publication Nos. 2006-133535 and H11-272063.

Japanese Patent Laid-Open Publication No. 2006-133535 discloses a toner density control method which controls toner density by detecting current toner density and comparing the detected toner density with a predetermined target density value based on image pixels.

Japanese Patent Laid-Open Publication No. H11-272063 discloses a method for controlling a toner supply level by detecting toner density at a specific point of time and storing the same and comparing the stored toner density with currently detected toner density.

According to the above cited references, a toner density sensor is provided at a development unit, and an amount of toner supplied into the development unit is adjusted based on the toner density detected by the toner density sensor.

Image quality of a transfer image formed on a transfer belt is not influenced only by the amount of toner supplied into the development unit, but also influenced by various factors, such as an exposure potential for forming an electrostatic latent image and a development potential. As described above, the methods for adjusting the amount of toner supplied into the development unit based on the toner density detected by the toner density sensor, have limits in achieving high image quality.

Considering this problem, there has been developed a technique of test printing a patch image and adjusting a toner supply amount according to the density of the patch image. The density of the patch image developed on a transfer belt is detected by a density sensor, and the toner supply amount is adjusted according to the detected density.

According to this conventional method for adjusting the toner supply amount, in order to detect the density of the patch image using the density sensor, practical printing operation is interrupted, and a setting time for test printing should be ensured. Accordingly, if the test printing operation is performed frequently, printing efficiency is deteriorated, and a toner is needlessly consumed largely by the test printing.

If a cycle of performing the test printing operation is set too long for that reason, it is difficult to immediately cope with the change in image quality, and efficiency of controlling the density of image quality is deteriorated. As a result, the density of the printed image becomes unstable.

### SUMMARY OF THE INVENTION

The present general inventive concept provides an image forming apparatus and a control method thereof that is capable of extending a cycle of detecting density of image quality long and maintaining density of a printed image stably by adjusting a toner supply amount according to changed density of a patch image which is detected by a density sensor with a predetermined detecting cycle.

Additional aspects and/or advantages of the general inventive concept will be set forth in part in the description which follows and, in part, will be obvious from the description, or may be learned by practice of the general inventive concept.

The foregoing and/pr other aspects and utilities of the present general inventive concept may be achieved by providing an image forming apparatus including an image input part, a development unit which is supplied with a toner and forms a developer to develop an input image inputted from the image input part, a transfer member to print or form a patch image, a density sensor which detects density of the patch image, and a toner supply amount control unit which sets a toner supply amount of the development unit according to changed density of the patch image which is detected by the density sensor with a predetermined detecting cycle, and applies the set toner supply amount to operation of printing the input image.

The toner supply amount control unit may set the toner supply amount according to difference between currently detected density and previously detected density.

The image forming apparatus may further include a storage part, in which a look-up table for discriminately setting the toner supply amount according to difference between values of the detected density is stored. The toner supply amount control unit may search the table stored in the storage part, and receives information for setting the toner supply amount.

When the operation of printing the input image is performed, the toner supply amount control unit may increase and decrease the toner supply amount according to pixels of the input image, and may set an extent of increasing or decreasing the toner supply amount according to change in density which is detected by the density sensor.

The toner supply amount control unit may derive toner density levels which are respectively set corresponding to values of density detected by the density sensor, and may set the toner supply amount according to difference between the toner density levels.

The development unit may be provided in plural according to colors to print a color image.

The development unit may include a toner container, and a toner supply motor to supply the toner contained in the toner container into the development unit, and the toner supply amount control unit may control the toner supply motor to increase or decrease the toner supply amount to a degree of the set toner supply amount.

The foregoing and/pr other aspects and utilities of the present general inventive concept may also be achieved by providing an image forming apparatus of a two-component developing type, which includes a development unit to develop an input image by receiving a toner, including a density sensor which detects density of a patch image for testing density of the input image, a control unit which sets a toner supply amount of the development unit according to a changed density of the patch image which is detected by the density sensor with a predetermined detecting cycle, and applies the set toner supply amount to an operation of printing the input image.

The image forming apparatus may further include a storage part to store a look-up table, and the control unit may search the look-up table based on a changed density of the patch image which is detected by the density sensor with the predetermined cycle to set the toner supply amount.

The storage part may store information for discriminately setting the toner supply amount according to difference between levels corresponding to values of the changed density which is detected by the density sensor with the predetermined detecting cycle.

The development unit may include a toner supply means which supplies the toner, and the control unit controls the toner supply means based on the set toner supply amount.

The foregoing and/pr other aspects and utilities of the present general inventive concept may also be achieved by providing a method of controlling an image forming apparatus including an image input part and a development unit which is supplied with a toner and forms a developer to develop an input image inputted from the image input part, the method including detecting density of a patch image by using a density sensor, setting a toner supply amount according to changed density of the patch image which is detected by the density sensor with a predetermined detecting cycle, and adjusting the amount of the toner which is supplied into the development unit based on the set toner supply amount.

The setting of the toner supply amount may include setting the toner supply amount according to difference between a value of currently detected density and a value of previously detected density.

The setting of the toner supply amount may include deriving a difference between toner density levels which are respectively set corresponding to values of the density detected by the density sensor, searching a pre-stored table based on the difference between the toner density levels, and receiving information for setting the toner supply amount.

The foregoing and/pr other aspects and utilities of the present general inventive concept may also be achieved by providing a method of controlling an image forming apparatus, the method including an image input part and a development unit which is supplied with a toner by a toner supply unit to develop an input image inputted from the image input part, the method including printing a patch image for testing density of the input image onto a transfer member, detecting density of the patch image by using a density sensor, setting a toner supply amount which is supplied into the development unit according to difference between a value of currently detected density by the density sensor and a value of previously detected density, and controlling the toner supply unit which supplies the toner into the development unit based on the set toner supply amount.

The toner supply unit may include a toner supply motor which supplies the toner contained in a toner container into the development unit, and the controlling includes controlling the toner supply motor to increase or decrease the toner supply amount which is supplied into the development unit.

The foregoing and/pr other aspects and utilities of the present general inventive concept may also be achieved by providing an image forming apparatus, including a density sensor to detect a patch image, a storage part to store a look-up table containing information to discriminately set a plurality of toner supply amounts according to differences between values of changed density of the detected patch image with the predetermined detecting cycle, and a control unit to select one of the toner supply amounts according to the difference and the changed density of the patch image, and to apply the selected toner supply amount to an operation of printing the input image.

The detected patch image may include a first patch image and a second patch image, and the information of the look-up table may include comprises a plurality of differences between the levels of the changed density between the first patch image and the second patch image.

The information of the look-up table may include a plurality of densities of the patch image, a plurality of levels to correspond to the densities, and the plurality of differences between the corresponding levels, and the control unit may select one of the differences according to the changed density of the patch image to select one of the plurality of toner supply amounts as the selected toner supply.

The patch image may include a previous patch image and a current patch image, the density sensor may detect the previous patch image and the current patch image to generate a previous density and a current density, and the control unit may search the information of the look-up table to select one of the plurality of toner supply amounts as the selected toner supply amount according to the difference representing the levels of the previous density and the current density, and one of the densities of the previous density and the current density of the patch image.

### BRIEF DESCRIPTION OF THE DRAWINGS

These and/or other aspects and utilities of the exemplary embodiments of the general inventive concept will become apparent and more readily appreciated from the following description of the embodiments, taken in conjunction with the accompanying drawings, of which:

FIG. 1A is a view illustrating a printing process of an image forming apparatus according to an embodiment of the present general inventive concept;

FIG. 1B is a block diagram of the image forming apparatus in accordance with the present invention according to an embodiment of the present general inventive concept;

FIG. 2 is a view illustrating a relationship between pixels of an input image and a toner supply amount;

FIG. 3 is a view illustrating a relationship between the pixels of the input image and the toner supply amount according to change in density detected by a density sensor;

FIG. 4 is a look-up table to set an extent of increasing or decreasing the toner supply amount according to a change in density of image quality detected by the density sensor;

FIG. 5 is a graph illustrating a method of adjusting the toner supply amount in consideration of a level corresponding to a change in the detected density of the image quality; and

FIG. 6 is a flowchart illustrating a method for controlling the image forming apparatus in accordance with the present invention according to an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

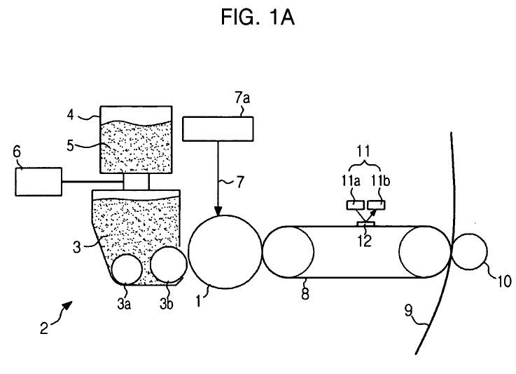

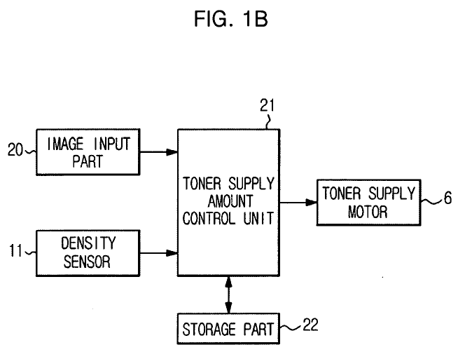

FIG. 1A is a view illustrating a printing process of an image forming apparatus according to an embodiment of the present general inventive concept.

The image forming apparatus according to the present embodiment includes a photosensitive drum 1, a development unit 2, an intermediate transfer belt 8, a printing medium, such as a transfer paper 9, and a transfer roller 10.

The development unit 2 includes a toner container 4, a toner supply motor 6, a supply roller 3a and a development roller 3b for performing the development using a developer 3. A toner 5 contained in the toner container 4 is supplied into a development unit 2 by the toner supply motor 6, and the supplied toner is mixed with a carrier to form the developer 3. The development unit 2 can be provided in plural according to colors to print a color image, and disposed near the photosensitive drum 1. Since the plurality of developing units for the color image is already widely known, the explanation thereof will be omitted.

An electrostatic latent image is formed on a surface of the photosensitive drum 1 by light 7 outputted from an exposure unit 7a. A visible image formed by transferring or attaching the developer 3 to the electrostatic latent image on the photosensitive drum 1 is transferred onto the transfer paper 9 which passes between the intermediate transfer belt 8 and the transfer roller 10.

The toner supply motor 6 is driven to adjust the toner supply amount according to a change in image quality. The toner supply motor 6 is controlled by a toner supply amount control unit 21, which will be described later.

As illustrated in FIG. 1B, the image forming apparatus according to the present embodiment includes the toner supply amount control unit 21 that outputs a control signal to the toner supply motor 6 to adjust the toner supply amount according to an input image which is inputted from an image input part 20.

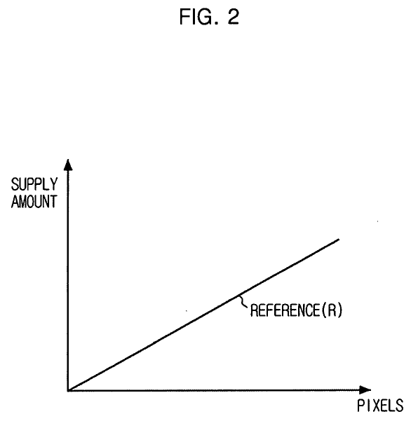

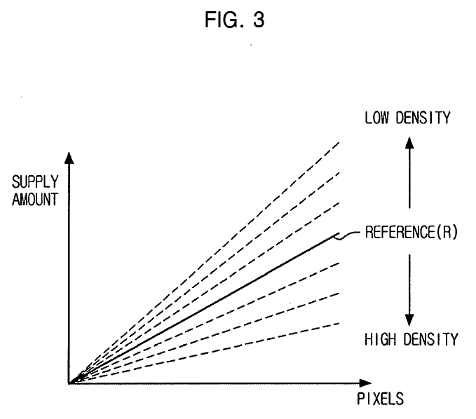

As illustrated in FIG. 2, the toner supply amount applied to the printing operation can be determined based on a reference R by which the toner supply amount is linearly increased in proportion to pixels of the input image. According to this method of determining the toner supply amount, as illustrated in FIG. 3, an adequate gradient of the reference R is selected according to the density detected by a density sensor, and the toner supply amount is determined based on the reference R having the selected gradient. When the detected density is lower than a reference density, it is set to increase the toner supply amount from the reference R. When the detected density is higher than the reference density, it is set to decrease the toner supply amount from the reference R.

AS illustrated in FIGS. 1A and 1B, the present embodiment is configured to optimally set the toner supply amount by using a density sensor 11 which detects the density of a patch image 12 formed on the intermediate transfer belt 8. The density sensor 11 can detect the density of the color image. The density sensor 11 includes a light emitting part 11a which emits light to the patch image 12, and a light receiving part 11b which receives the light reflected from the patch image 12.

The density sensor 11 transmits a detected value of the density of the patch image to the toner supply amount control unit 21. In response to the detected value of the density of the patch image from the density sensor 11, the toner supply amount control unit 21 sets the toner supply amount corresponding to change in the density of image quality of the patch image, and controls the toner supply motor 6 according to the set toner supply amount, thereby adjusting the toner supply amount. The toner supply amount control unit 21 sets the toner supply amount based on a look-up table. The look-up table may be pre-stored in the storage part 22.

The patch image may be formed as a pattern included in the visible image or an additional image disposed adjacent to the visible image. The patch image may be formed as an image having a single color or an image having a black and white level. The patch image may be simultaneously formed together wither the visible image, or the visible image and the patch image may be sequentially formed. The patch image may be formed according to a predetermined cycle of the density sensor 11. In this case, the patch images to be detected by the density sensor 11 are formed at an interval corresponding to the predetermined cycle, such that the density sensor 11 can detect two densities of the patch images.

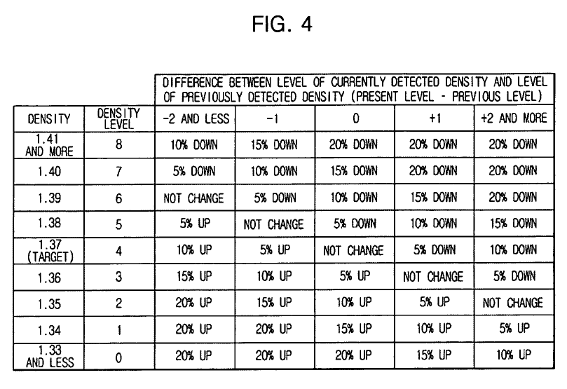

Referring to FIG. 4, the look-up table stored in the storage part 22 shows that the toner supply amount is set discriminately according to a difference between a level of the currently detected density and a level of the previously detected density. Here, the level of the density is a value that is preset corresponding to the value of the density detected from the density sensor.

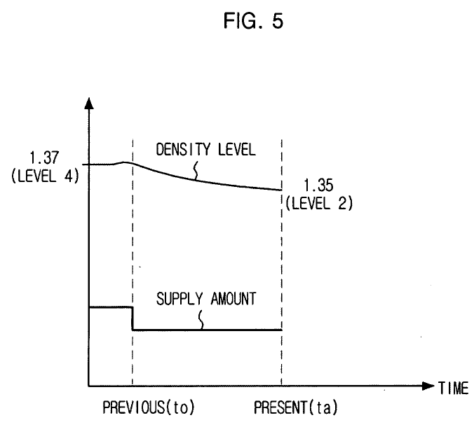

As illustrated in FIG. 5, if the detected value of the density of the patch image from the density sensor 11 at a previous time to is 1.37, i.e., a level 4 of the toner density, and the detected value of the density of the patch image at a current time ta is 1.35, i.e., a level 2 of the toner density, the difference between the level of the currently detected toner density and the level of the previously detected toner density is −2. From the look-up table illustrated in FIG. 4, when the value of the currently detected density is 1.35 and the difference between the levels of the toner densities is −2, it is determined that the toner supply amount is set to be increased by 20%, i.e., 20% UP, in order to increase the density to a target value of 1.37.

According to the present embodiment, the currently detected toner density may be referred to as a first density, and the previously detected toner density may be referred to as a second density or a reference density. The second density can be updated with the currently detected toner density when a next difference is calculated between the currently detected toner density and a next toner density detected from a next patch.

When the developer having a toner and a carrier is applied to form the image, the toner remains as the visible image, and the carrier may not remain in the visible image. In this case, the density may represent a toner density of the patch image. However, it is possible that the density may represent a density of the developer that is used to form the visible image and the patch image.

As described above, since the density of the patch image is detected by the density sensor 11 and the toner supply amount is adjusted according to the change in the detected density of the image, the toner supply amount can be adequately adjusted even when a detecting cycle of the density sensor is set to a longer period that a conventional reference period. Accordingly, unnecessary consumption of the toner is prevented, and the density of the image can be maintained stably by the adequate toner supply amount.

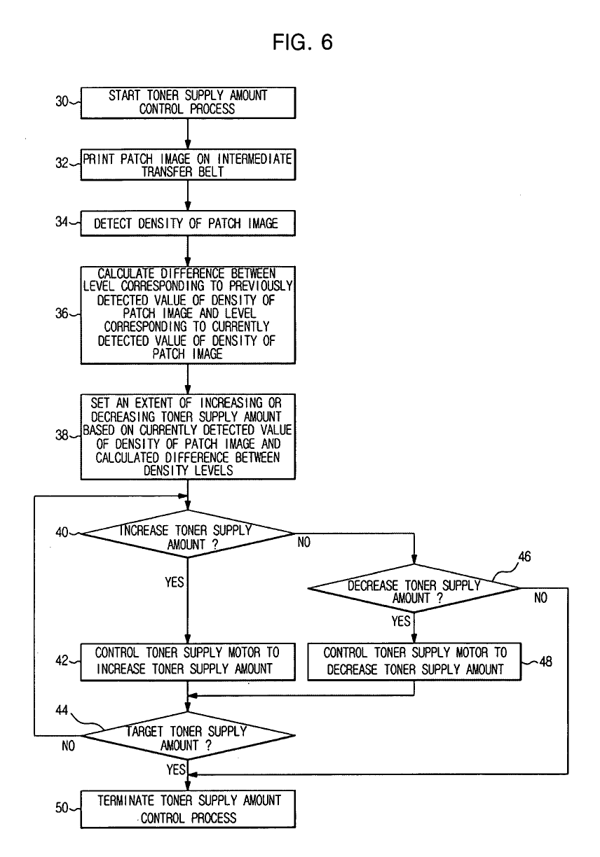

Hereinafter, a method of controlling an image forming apparatus according to an embodiment of the present general inventive concept will be described with reference to FIG. 6.

Referring to FIGS. 1-6, when a user inputs a command for setting the toner supply amount or a status of the image forming apparatus is under a predetermined condition, a printing operation is interrupted, and a toner supply amount control process according to the present embodiment is started at operation 30.

The patch image 12 is printed on the intermediate transfer belt 8 at operation 32. The density sensor 11 detects the density of the patch image, and transmits the same to the toner supply amount control unit 21 at operation 34.

In response to the detected value of the density of the patch image from the density sensor 11, the toner supply amount control unit 21 calculates the difference between the level corresponding to the previously detected value of the density of the patch image and the level corresponding to the currently detected value of the density of the patch image at operation 36.

The toner supply amount control unit 21 searches information of the toner supply amount, which corresponds to the value of the currently detected density of the patch image and the difference between the level of the currently detected toner density and the level of the previously detected toner density, from the table (see FIG. 4) stored in the storage part 22, and sets an extent of increasing or decreasing the toner supply amount based on the searched result at operation 38.

The toner supply amount control unit 21 determines whether to increase the toner supply amount from the previous supply amount at operation 40. If the toner supply amount control unit 21 determines to increase the toner supply amount, it controls the toner supply motor 6 to increase the toner supply amount at operation 42.

The toner supply amount control unit 21 determines whether the increased toner supply amount reaches to a target toner supply amount at operation 44. If the toner supply amount control unit 21 determines that the increased toner supply amount does not reach to the target toner supply amount, the process goes to operation 40.

If the toner supply amount control unit 21 determines not to increase the toner supply amount at operation 40, it determines whether to decrease the toner supply amount from the previous supply amount at operation 46. If the toner supply amount control unit 21 determines to decrease the toner supply amount, it controls the toner supply motor 6 to decrease the toner supply amount at operation 48.

The toner supply amount control unit 21 determines whether the decreased toner supply amount reaches to the target toner supply amount at operation 44. If the toner supply amount control unit 21 determines that the decreased toner supply amount does not reach to the target toner supply amount, the process goes to operation 40.

If the toner supply amount control unit 21 determines that the set toner supply amount reaches to the target toner supply amount at operation 44, or determines not to decrease the toner supply amount (i.e., the current toner supply amount is kept same as the previous supply amount) at operation 46, it is not needed to change the toner supply amount, and thus the toner supply amount control process is terminated at operation 50.

As apparent from the above description, according to the image forming apparatus of the present general inventive concept, since the density of the patch image is detected by the density sensor and the toner supply amount is adjusted according to the change in the detected density of the image, a cycle of test printing the patch image can be extended longer than a conventional image forming apparatus, unnecessary consumption of the toner is prevented, and the density of the printed image can be maintained stably, thereby increasing reliability of the product.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An image forming apparatus comprising:
an image input part;
a development unit to develop an input image inputted from the image input part using a developer;
a transfer member to form a patch image;
a density sensor which detects density of the patch image; and
a toner supply amount control unit which sets a toner supply amount of the development unit according to changed density of the patch image which is detected by the density sensor with a predetermined detecting cycle, and applies the set toner supply amount to an operation of printing the input image.

2. The image forming apparatus according to claim 1, wherein the toner supply amount control unit sets the toner supply amount according to a difference between currently detected density and previously detected density.

3. The image forming apparatus according to claim 1, further comprising:
a storage part to store a look-up table for discriminately setting the toner supply amount according to a difference between values of the detected density is stored,
wherein the toner supply amount control unit searches the look-up table stored in the storage part, and receives information for setting the toner supply amount according to the look-up table.

4. The image forming apparatus according to claim 1, wherein when the operation of printing the input image is performed, the toner supply amount control unit increases or decreases the toner supply amount according to pixels of the input image, and sets an extent of increasing or decreasing the toner supply amount according to a change in density which is detected by the density sensor.

5. The image forming apparatus according to claim 1, wherein the toner supply amount control unit derives toner density levels which are respectively set corresponding to values of density detected by the density sensor, and sets the toner supply amount according to a difference between the toner density levels.

6. The image forming apparatus according to claim 1, wherein the development unit comprises a plurality of development units according to colors to print a color image.

7. The image forming apparatus according to claim 1, wherein:
the development unit includes a toner container, and a toner supply motor for supplying the toner contained in the toner container into the development unit; and
the toner supply amount control unit controls the toner supply motor to increase or decrease the toner supply amount to a degree of the set toner supply amount.

8. An image forming apparatus, comprising:
a density sensor which detects density of a patch image; and
a control unit which sets a toner supply amount of the development unit according to a changed density of the patch image which is detected by the density sensor with a predetermined detecting cycle, and applies the set toner supply amount to an operation of printing the input image.

9. The image forming apparatus according to claim 8, further comprising:
a storage part to store a look-up table,
wherein the control unit searches the look-up table based on a changed density of the patch image which is detected by the density sensor with the predetermined cycle to set the toner supply amount.

10. The image forming apparatus according to claim 9, wherein the storage part stores in the look-up table information to discriminately set the toner supply amount according to a difference between levels corresponding to values of the changed density which is detected by the density sensor with the predetermined detecting cycle.

11. The image forming apparatus according to claim 9, wherein:
the development unit includes a toner supply unit which supplies the toner; and
the control unit controls the toner supply unit based on the set toner supply amount.

12. A method of controlling an image forming apparatus, comprising:
detecting density of a patch image by using a density sensor;
setting a toner supply amount according to changed density of the patch image which is detected by the density sensor with a predetermined detecting cycle; and
adjusting the amount of the toner which is supplied into the development unit based on the set toner supply amount.

13. The method according to claim 12, wherein the setting of the toner supply amount comprises setting the toner supply amount according to a difference between a value of currently detected density and a value of previously detected density.

14. The method according to claim 13, wherein the setting of the toner supply amount comprises:
deriving a difference between toner density levels which are respectively set corresponding to values of the density detected by the density sensor;
searching a pre-stored table based on the difference between the toner density levels; and
receiving information for setting the toner supply amount.

15. A method of controlling an image forming apparatus, comprising:
printing a patch image for testing density of an input image onto a transfer member;
detecting density of the patch image by using a density sensor;
setting a toner supply amount which is supplied into a development unit according to a difference between a value of currently detected density by the density sensor and a value of previously detected density; and
controlling a toner supply unit which supplies the toner into the development unit based on the set toner supply amount.

16. The method according to claim 15, wherein:
the toner supply unit includes a toner supply motor which supplies the toner contained in a toner container into the development unit; and
the controlling includes controlling the toner supply motor to increase or decrease the toner supply amount which is supplied into the development unit.

17. An image forming apparatus, comprising:
a density sensor to detect a patch image;
a storage part to store a look-up table containing information to discriminately set a plurality of toner supply amounts corresponding to a plurality of differences between values of changed density of the detected patch image with the predetermined detecting cycle; and
a control unit to select one of the toner supply amounts according to one of the differences and the changed density of the patch image, and to apply the selected toner supply amount to an operation of printing the input image.

18. The image forming apparatus according to claim 17, wherein the detected patch image comprises a first patch image and a second patch image, and the information of the look-up table comprises a plurality of differences between the levels of the changed density between the first patch image and the second patch image.

19. The image forming apparatus according to claim 17, wherein:
the information of the look-up table comprises a plurality of densities of the patch image, a plurality of levels to correspond to the densities, and the plurality of differences between the corresponding levels; and
the control unit selects one of the differences according to the changed density of the patch image to select one of the plurality of toner supply amounts as the selected toner supply amount.

20. The image forming apparatus according to claim 17, wherein:
the patch image comprises a previous patch image and a current patch image;
the density sensor detects the previous patch image and the current patch image to generate a previous density and a current density; and
the control unit searches the information of the look-up table to select one of the plurality of toner supply amounts as the selected toner supply amount according to the difference representing the levels of the previous density and the current density, and one of the densities of the previous density and the current density of the patch image.
